(19) United States
(12) Patent Application Publication
(10) Pub. No.: US 2005/0016063 A1
(43) Pub. Date: Jan. 27, 2005

(54) Rim edging

(76) Inventor: Harold K. Shen, Glen Mills, PA (US)

Correspondence Address: HAROLD K. SHEN, 15 MAPLE LANE, GLEN MILLS, PA, 19342, US

(21) Appl. No.: 10/420,385

(22) Filed: Apr. 22, 2003

(51) Int. Cl. A01G 1/00

(52) U.S. Cl. 47/33

(57) ABSTRACT

A new type of landscape edging device, namely RIM EDGING, is invented for mulching around the base of a tree and lawn/mulch edge control. The present invention, RIM EDGING, is a plurality of sections of concrete block that are connected together in a rim-like configuration. Each section comprises a recessed top surface, a wrap-around flange along the inner circumference, and joint connectors for coupling with one another. These design features along with the sturdy construction make the RIM EDGING more effective than the existing edging devices available today for (a) better care of trees, (b) better lawn/mulch edge control, (c) reduced yardwork, (d) reduced cost and maintenance of landscape edging, (e) enhanced appearance of the landscape.

### CROSS-REFERENCE TO RELATED APPLICATIONS

Not Applicable

### FEDERALLY SPONSORED RESEARCH OR DEVELOPMENT

Not Applicable

### SEQUENCE LISTING

Not Applicable

### FIELD OF THE INVENTION

This invention relates to the field of landscaping and in particular to a landscape edging device.

### BACKGROUND OF THE INVENTION

One common problem of mulching around the base of a tree is that grass growth spreading from the adjoining lawn makes the mulch area appears unsightly. Another common problem is that it is difficult to prevent the mulch from scattering or spilling over to the adjoining lawn.

One of the common solution is digging a deep ring-shaped wide trench in the ground around the base of a tree to separate the mulch area from the lawn. Other solutions include using wood, polyethylene, or metallic edgings to serve as landscape barriers around trees, shrubs and flower beds. These solutions are not always successful. Either a trench or the landscape edgings available today are incapable of restricting spread of unwanted grasses effectively. Most of the edgings deteriorate over time and all are susceptible to damage by lawn mowers or grass trimmers. A trench around the base of a tree is totally ineffective for preventing mulch from spilling onto the adjoining lawn, Over a short period of time, the trench is filled with debris, mulch, grasses and weeds. Consequently, hard yardwork often needs to be repeated. Damaged edgings need to be replaced. The existing solutions, which are neither economical nor convenient, require a great deal of yardwork. Therefore, there is a demand for a new solution.

### SUMMARY OF THE INVENTION

The object of the present invention is to provide a landscape edging device which solves the existing problems of mulching around the base of a tree and lawn/mulch edge control. The present invention (RIM EDGING) is uniquely designed to provide the capability allowing this object to be accomplished.

The RIM EDGING is a plurality of sections of concrete block that are connected together in a rim-like configuration. It is divided into sections for the convenience of installation. Each section comprises a recessed top surface and a “wrap-around”-shaped flange along the inner circumference. These design features make the RIM EDGING capable of retaining rain water and enhancing the effectiveness for holding mulch together. As a result, tree roots take up more water from rain while the base of the tree is protected and appears neat all the time. Moreover, since the RIM EDGING is to be placed in the ground, it creates an effective underground wall to impede spread of grasses from the adjoining lawn. By using the RIM EDGING, it reduces the need for repeating the tedious work of digging and cleaning up the debris, scattered mulch, grasses and weeds that would otherwise accmulate in an uncovered trench.

Other design features including a low center of gravity, a broad flat bottom, and joint connectors for coupling with adjoining sections make the RIM EDGING stable and strongly anchored into the ground, not susceptible to being separated from one another over time.

The RIM EDGING sections are made of concrete mix. The sturdy construction makes the RIM EDGING long-lasting, weather-proof, and, most important of all, not susceptible to damage by either lawn mowers or grass trimmers.

The present invention provides advantages including (a) a highly effective way of taking better care of trees, (b) a highly effecient way of lawn/mulch edge control, (c) reduced maintenance and yardwork, (d) reduced cost of landscape edging, and (e) enhanced appearance of the landscape.

### DRAWINGS—FIGURES

Three sheets of drawings are presented. Sheet one contains FIG. 1. Sheet two contains FIGS. 2 and 3. Sheet three contains FIG. 4.

FIG. 1 is a top view of the present invention.

FIG. 2 is a perspective view of a RIM EDGING section.

FIG. 3 shows the joint connectors at the two opposing ends of a RIM EDGING section.

FIG. 4 is a detailed description of a RIM EDGING section.

### DRAWING ITEM REFERENCE NUMERALS

2 inner circumference flange
4 outer circumference flange
6 recessed top surface
8 bottom base
10 left end joint connector
12 right end joint connector

### DETAILED DESCRIPTION OF THE INVENTION

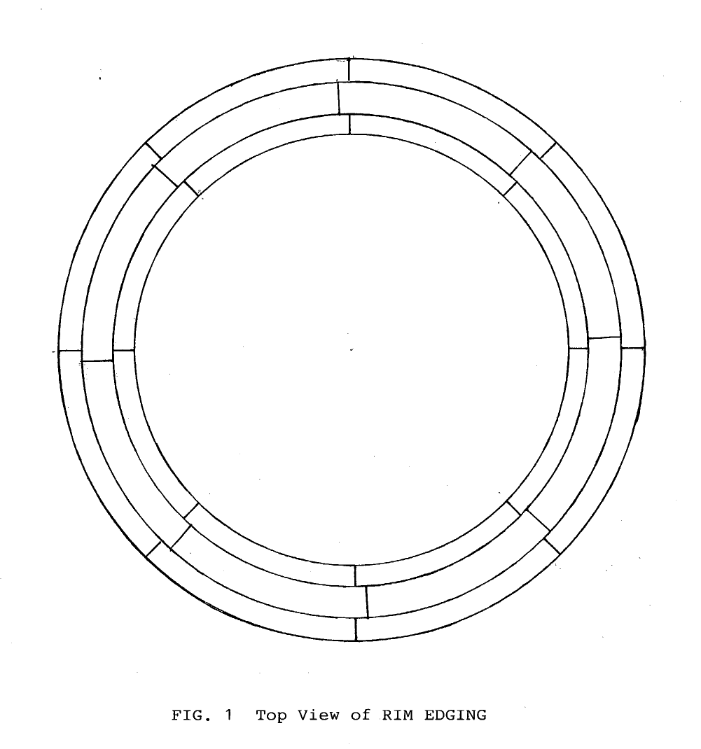

FIG. 1 describes the top view of the RIM EDGING. In this figure it is shown that the RIM EDGING comprises eight sections assembled in a rim-like configuration. The number of sections depends on the size of the base of a tree requiring mulching. It may be eight for a small base or sixteen for a large base. The RIM EDGING is divided into sections for the convenience of installation. The sections are sturdy yet neither bulky nor heavy.

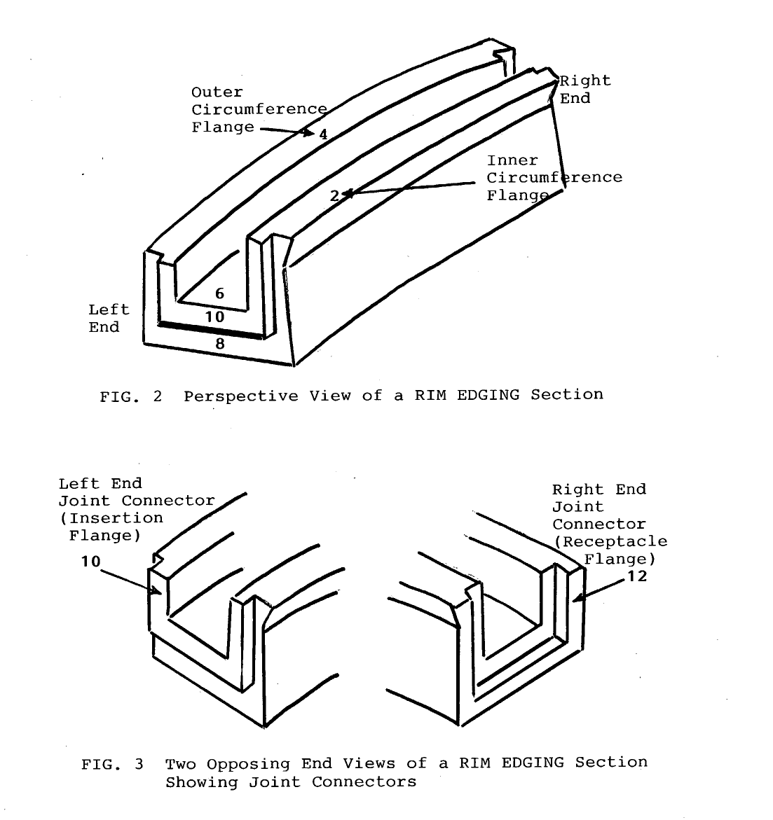

FIG. 2 is a perspective view of one of the RIM EDGING sections. As shown, each section resembles a section of a rim, comprising an inner circumference flange 2. an outer circumference flange 4, and a recessed top surface in the center. The inner circumference flange 2 is configured to have a “wrap-around” effect which enhances the effectiveness of the RIM EDGING for containing the mulch. The recessed top surface in the center 6 is for retaining rain water. The bottom base 8 of each RIM EDGING section is configured to be flat and wide for the stability of the edging.

The two opposing ends of each RIM EDGING section have joint connectors for coupling with adjoining sections. As shown in FIG. 3, the left end of each RIM EDGING section is configured to have a three-sided insertion flange 10. The right end of each RIM EDGING section is recessed to form a three-sided receptacle flange 12. When the insertion flange 10 of a RIM EDGING engages with the receptacle flange 12 of an adjoining section, the two sections become interlocked together. By using these joint connectors, the sections are connected together to form the RIM EDGING as shown in FIG. 1.

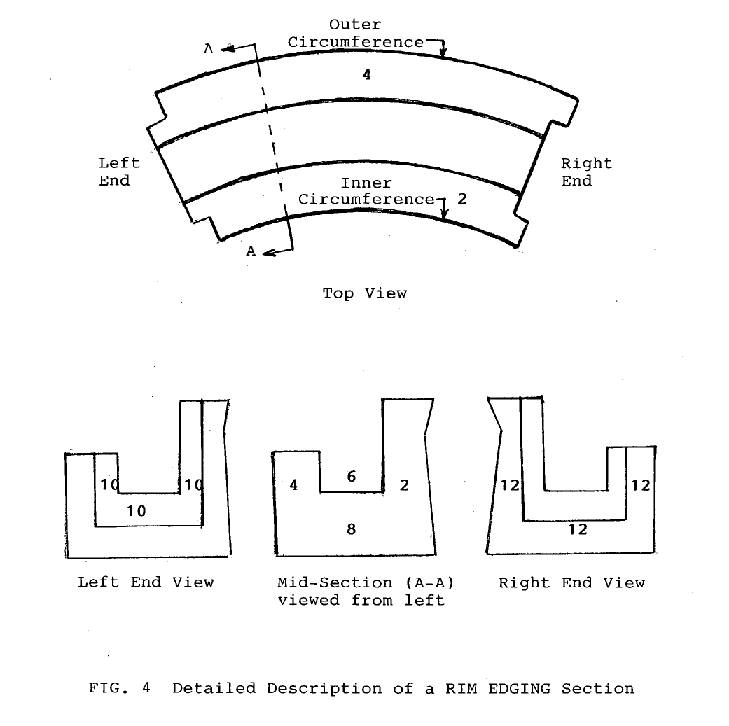

A complete description of each of the RIM EDGING sections is detailed in FIG. 4. It describes the RIM EDGING section from four different views: the top view of the outer and inner circumference flanges (4 & 2), the left end and right end views of joint connectors (10 & 12) at the two opposing ends of each RIM EDGING section and a mid-section view which depicts the cross section of each RIM EDGING section.

The RIM EDGING sections are made of concrete mix. They are designed to be neither bulky nor heavy for easy installation. So, the RIM EDGING is divided into eight or sixteen sections depending on the size of the base of a tree requiring mulching.

Preparation for the installation requires digging a ring-shaped trench around the trunk of a tree. The depth and width of the trench should match the height of the outer circumference and the bottom base of the RIM EDGING respectively. The RIM EDGING sections are placed inside the trench and connected together as shown in FIG. 1.

1. A RIM EDGING device comprising a plurality of sections of concrete block connected together in a rim-like configuration, said sections each having a recessed top surface, an outer circumference flange, a wrap-around shaped flange along the inner circumference, and joint conectors for coupling with adjoining sections.

2. The RIM EDGING of claim 1 wherein said sections resemble sections of a rim.

3. The RIM EDGING of claim 1 wherein said top surface is recessed between two said circumference flanges.

4. The RIM EDGING of claim 1 wherein said inner circumference flange is configured to have a “wrap-around” effect as shown in FIG. 2.

5. The RIM EDGING of claim 1 wherein said joint connectors comprise a three-sided insertion flange at one end of each said section and a three-sided receptacle flange at the opposing end of each said section as shown in FIG. 3.

6. The RIM EDGING of claim 1 wherein said sections are configured to have a wide flat bottom with a low center of gravity.
